(19) United States
(12) Patent Application Publication
(10) Pub. No.: US 2007/0033777 A1
(43) Pub. Date: Feb. 15, 2007

(54) Luminous urn

(76) Inventor: Ronald Lee Blessing, Dallas, OR (US)

Correspondence Address: LAW OFFICE OF CARL. D. CROWELL, P. O. BOX 923, SALEM, OR, 97308-0923, US

(21) Appl. No.: 11/204,905

(22) Filed: Aug. 15, 2005

(51) Int. Cl. A61G 17/00

(52) U.S. Cl. 27/1

(57) ABSTRACT

A luminescent urn with a base, vertical sections, and a removable top with a structure comprised principally of luminescent solid surface material.

### BACKGROUND

This invention relates to urns used to store cremation ashes, specifically to urns made of solid surface material incorporating a luminous, phosphorescent, or light-emitting property. Such a lighted monument is thought to broaden and enhance the impact of seeing placement of remains and contemplating the contents of the urn.

Prior art discloses how to make urns of solid stone. Document FR 2 681 624 describes a stone urn made by assembling a tubular stone block with stone disks of the same diameter forming a lid and pedestal, one face of the disk being bonded to the end rim of the block. These urns are designed to be preserved and concealed within a funerary monument slab, the urns being inserted in a cylindrical bore of the slab. These urns have the drawback of requiring numerous, delicate machining operations in which a stone slab is cored for the extraction of a column. The column is then truncated to obtain disks while the axial part of the remainder of the column is bored. The column is then truncated to obtain the blocks, and finally the disks are bonded to the ends of the blocks.

Document FR 2 722 229 describes a type of urn monument formed by a stack of cinerary urns. Each box has an aperture on a lateral face to introduce the cinerary urn, this single side aperture being closed by a door or a plate, while the lower and upper fixed faces comprise shapes in relief, both recessed and raised, which are designed to enable the boxes to fit together during the stacking. These bulky boxes with a complex shape also have the drawback of requiring numerous steps of fashioning and joining, and have a prohibitive cost such that a stone structure cannot be envisaged.

U.S. Pat. No. 6,493,911 discloses the invention of a stone urn that is designed to be used in a modular form that can be stacked to form a monument. This modular urn is made from stone comprising a cylindrical block hollowed out from a first end to a second end and a lid comprising a sealing portion sealing the first end of the block. The assembling portion projects from the first end when the sealing portion seals the first end, the second end; of the block comprises an internal countersinking bore capable of receiving an inner seal and capable of receiving an assembling portion projecting from a lid of another identical urn. When multiple urns are joined, a monument is formed. These modular urns are limited to cylindrical shapes.

A limitation of prior art urns includes the requirement that they be carved from a solid piece of stone, hollowed out through time consuming and expensive means. This results in the requirement of a large source block or volume of source material.

The urns of the prior art generally also suffer from the limitation that when made from traditional materials, they cannot emit light and thus do not enhance or create the emotional effect of a luminescent urn.

Prior art urns that have attempted to overcome this deficiency fail in their attempts by requiring a separate lighting element such as a lamp, and an energy source that must be connected to a supply, battery or reservoir that must be replenished.

U.S. Pat. No. 6,785,939 discloses such an urn for use as a lighted memorial. The device is composed of a coupling of a storage receptacle for cremation ashes along with an active display of light. This urn is a two section upright structure having a base section that is provided with a bottom surface to rest on a support such as a mantle or table. The top surface of the base section receives a light-transmissive housing, which contains a fluid reservoir and a light generating flame. The light generating flame is sustained by the combustion of fuel in the fluid reservoir which must be regularly refilled. Without fuel there is no flame and its enhancing effect is lost. Additionally the flame must be manually lit for the urn to emit light. Such a flame requires regular maintenance and poses a potential fire hazard, limiting the use of such a flame in an unattended area.

What is desired and herein disclosed is an improved product which provides for an urn with maintenance free light-emission, reduced cost, which enhances the observer's emotional experience while performing the function of an urn in an attractive manner. The specific improvements of the present invention relate to the utilization of luminescent solid surface material in the reduced cost construction of a luminescent, phosphorescent, or light-emitting urn capable of storing crematory ashes.

### SUMMARY OF THE INVENTION

The subject of this invention is an urn made substantially of luminescent, phosphorescent, or light emitting solid surface material. The unique quality of the urn's constituting material causes its luminescent surfaces to glow while performing the function of storing crematory ashes. The preferred embodiment further permits efficient construction at reduced cost.

### BRIEF DESCRIPTION OF THE DRAWINGS

FIG. 1 is a perspective view of the complete urn with its top on.

FIG. 2 is a cross section view of the luminescent solid surface or artificial stone material used to build the urn indicating luminous properties.

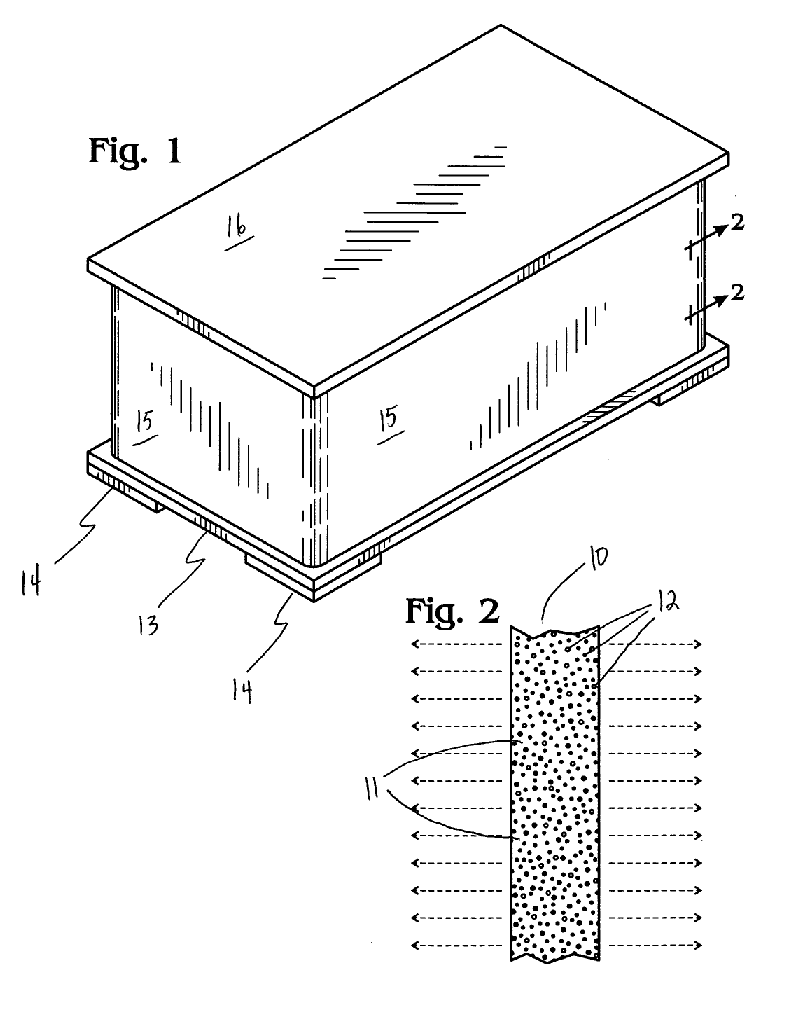

### PREFERRED EMBODIMENT OF THE INVENTION

In its preferred embodiment, the urn is made from pieces of luminescent solid surface material 10 affixed together with adhesive or chemical bonding. The base 13 is a horizontal rectangular piece with four legs 14 affixed. Each leg 14 has one 90-degree angle. The 90-degree corner of each leg 14 is matched flush with the corners of the rectangular base 13. The base 13 is placed with its legs 14 facing down.

Four vertical pieces make up the vertical sides 15 of the box shaped urn. In the preferred embodiment, the width of each vertical side 15 is slightly smaller than the side of the base 13 to which it will be affixed. These vertical sides 15 are affixed to each other and to the base 13. The base 13 forms the bottom of the urn.

A rectangular piece large enough to simultaneously touch the top edge of the vertical sides 15 of the urn forms the top 16. The size of the top 16 prevents it from falling into the urn. A protrusion is affixed to the bottom surface of the top in a manner which allows the protrusion to nearly touch each inside corner formed by the vertical sides 15 when the top 16 is placed on the urn. The protrusion prevents the top 16 from sliding off the urn.

The luminous solid stone or luminous solid surface material of which one or more of the pieces of the urn are formed is well known. There are a wide variety of luminous solid surface materials which may be utilized with the addition of a luminous component in manufacture. In the preferred embodiment, the luminous solid surface material is comprised of approximately 63% by weight Aluminum Trihydrate filler 12 such as is sold under the trade name Gtantex®, from Gruber Systems of Valencia, Calif. and 37% by weight bonding compound 11. The bonding compound 11 is preferably comprised of a polyester resin such as Polylite® manufactured by Reichhold, Inc., and a luminescent compound such as Pylam Phosphorescence sold by Pylam Products mixed to a ratio of approximately 36-1 by weight. The resulting bonding compound 11 with luminescence is mixed with the filler 12 and catalyzed with an organic peroxide catalyst. Though the preferred mixture is disclosed, useful luminescent solid surface material 10 may be fabricated with up to 16% by weight of luminescent compound. Higher percentages of luminescent compound create greater luminescence, though with significant greater costs.

While the preferred embodiment has been above described, it is disclosed that a luminous urn may be fabricated from the carving or molding of the luminous solid surface material. As the formation of luminous solid surface material is through a setting of a fluidic compound, such fabrication may take place in molds or with the formation of solid blocks that may be carved, cored and treated as traditional stone.

I claim:

1. A luminescent urn for storing cremation ashes comprised substantially of luminescent solid surface material.

2. A luminescent urn comprising:
(a) a base section,
(b) a plurality of vertical sections affixed on said base creating a vessel for storing the cremation ashes,
(c) a removable top for closing said vessel,
(d) wherein at least one of said sections is comprised of luminescent solid surface material.

3. (canceled)

4. The luminescent urn of claim 2 wherein said luminescent urn is comprised substantially of luminescent solid surface material.

5. The luminescent urn of claim 2 further comprising legs affixed to the bottom surface of the base section.

6. The luminescent urn of claim 1 further comprising legs affixed to a bottom surface of said luminescent urn.

7. A luminescent urn comprising:
(a) abase section,
(b) a vertical section affixed to said base creating a vessel for storing the cremation ashes,
(c) a removable top for closing said vessel,
(d) wherein at least one of said sections is comprised of luminescent solid surface material.

8. The luminescent urn of claim 7 wherein said luminescent urn is comprised substantially of luminescent solid surface material.

9. The luminescent urn of claim 7 further comprising legs affixed to the bottom surface of the base section.
